(19) United States
(12) Patent Application Publication
(10) Pub. No.: US 2014/0333876 A1
(43) Pub. Date: Nov. 13, 2014

(54) Color Filter Substrate And Indium-Tin-Oxide Film Pattern Structure And Manufacturing Method Thereof, And Liquid Crystal Display

(71) Applicant: Shenzhen China Star Optoelectronics Technology Co. Ltd, Shenzhen, Guangdong (CN)

(72) Inventors: Kisun Kang, Shenzhen (CN); Chihsheng Ko, Shenzhen (CN); Wenchao He, Shenzhen (CN)

(73) Assignee: Shenzhen China Star Optoelectronics Technology Co., Ltd., Shenzhen, Guangdong (CN)

(21) Appl. No.: 14/003,034

(22) PCT Filed: Jun. 28, 2013
(86) PCT No.: PCT/CN2013/078246

§ 371 Date: Sep. 4, 2013

(30) Foreign Application Priority Data
May 8, 2013 (CN) 201310167143.7

(51) Int. Cl. G02F 1/1335; G02B 5/20

(52) U.S. Cl. CPC G02F 1/133514; G02B 5/201; G02F 1/133516; G02F 2001/133519
USPC 349/106; 359/891; 428/195.1; 204/192.26; 216/24

(57) ABSTRACT

The present invention relates to a CF substrate and an ITO film pattern structure and a manufacturing method thereof and a liquid crystal display. The present invention provides a CF substrate, including a glass substrate, a black matrix and a CF unit formed on the glass substrate, and an ITO film pattern structure covering the black matrix and the CF unit; the ITO film pattern structure is composed of a first portion corresponding in shape to an effective display zone and second portions corresponding in shape to transfer pads. The present invention also provides an ITO film pattern structure and a manufacturing method of a CF substrate and a liquid crystal display. The CF substrate and the ITO film pattern structure and the manufacturing method thereof and the liquid crystal display according to the present invention can lower down the capacitances of gate lines, data lines, and some signal lines in fan-out areas and wire-on-array areas so as to reduce the loading of the gate lines, the data lines, and the some signal lines thereby improving the displaying performance of the liquid crystal panel.

### BACKGROUND OF THE INVENTION

1. Field of the Invention

The present invention relates to the field of liquid crystal display, and in particular to a color filter substrate and an indium-tin-oxide film pattern structure and a manufacturing method thereof, and a liquid crystal display.

2. The Related Arts

Liquid crystal displays have advantages, such as being light and compact and low power loss, and being free of radiation, and are recently widely used in various electronic products, including lots of products, such as notebook computers, mobile phones, digital cameras, projectors, palm-top devices, and portable music players.

The art for manufacturing thin-film transistor liquid crystal display (TFT-LCD) that is currently used generally comprises the following processes: forming a TFT array on a TFT substrate; forming a color filter (CF) pattern structure and an indium-tin-oxide film pattern structure on a CF substrate; arranging the two substrates to form a liquid crystal box; and assembling modules, such as mounting a surrounding circuit ad assembling a backlight module.

Indium tin oxides are generally abbreviated as ITO and are a n-type semiconductor material having high electrical conductivity, high visible light permeability, high mechanical hardness, and excellent chemical stability. Thus, it is the most commonly used film material for transparent electrodes of liquid crystal displays, plasma display panels, electroluminescent display panels, touch panels, solar cells, and other electronic equipment. For example, indium tin oxides are commonly used to make leads that connect pixels on a liquid crystal display panel.

Heretofore, patternization of ITO film is generally carried out with the following processes.

(1) Wet etching method, which generally comprises the following steps:

A layer of ITO film is first formed on a substrate through sputtering in a vacuum coating machine; afterwards, a layer of photoresist is uniformly applied on the ITO film; then masks are used to carry out steps including exposure and developments for patternizing the photoresist; then, a wet etching process is applied to etch off the portions of the ITO film that are not covered the photoresist, and finally, a release agent is applied to remove the patternized photoresist to form the desired pattern structure of ITO film.

(2) Dry etching method, which generally comprises the following steps:

A layer of ITO film is first formed on a substrate through sputtering in a vacuum coating machine; afterwards, a layer of photoresist is uniformly applied on the ITO film; then masks are used to carry out steps including exposure and developments for patternizing the photoresist; then, a dry etching process is applied to etch off the portions of the ITO film that are not covered the photoresist by using an etchant gas so as to form the desired pattern structure of ITO film.

(3) Lift-off method, which generally comprises the following steps:

A layer of photoresist is first coated on a substrate; then, exposure and developments are carried out to remove the portions of the photoresist where a desired pattern of an ITO film is to be formed from the substrate; then, an ITO film is coated on the substrate with the patternized photoresist by using a vacuum coating machine; and finally, a releasing operation is carried out on the substrate that comprises the patternized photoresist and the ITO film to remove the remaining photoresist and the portions of the ITO film attached thereon so as to obtain a substrate that comprises the desired pattern structure of the ITO film.

In manufacturing a large-sized liquid crystal panel, the resistive and capacitive loading gate lines, data lines, and some signal lines (such as gate high level signal (V_{gh}), allowable output signal (OE), and clock signal (CKV)) greatly affect the displaying of the panel. When the resistive and capacitive loading of the gate lines and the signal lines is excessively large, this, if reflected on the panel, would result in poor performance of displaying of the panel and the occurrences of mura.

HVA (High Vertical Alignment) technology that is currently used is to form coating on an entire surface for formation of an ITO film pattern of a CF substrate (which is located on one side of the CF substrate to be distant from a TFT substrate). However, except the portions of the ITO film of the CF substrate that corresponds to an effective display zone (AA zone), the portions of the ITO film of the CF substrate that correspond to the surrounding fan-out area and wire-on-array area are not necessary.

Referring to FIG. 1, a top plan view is given to show an ITO film pattern structure of a conventional CF substrate. It can be seen from the spatial relationship that the CF substrate 2 is located at a location above and corresponding to a TFT substrate 1. An ITO film pattern structure 3 on a surface of the CF substrate 2 is a film coated over the entire surface. The ITO film pattern structure 3 is indicated by an area in which dots are distributed in FIG. 1 and it can be seen that it covers the entire CF substrate 2 and includes the entirety of an associated effective display zone 4. In fact, except the ITO film pattern structure 3 that is included in the dotted area corresponding to the effective display zone 4 and the ITO film pattern structure 3 that is included in the dotted areas corresponding to the surrounding fan-out areas and wire-on-array areas, the remaining areas are not necessary. In the state of the art, the wiring of a data line in a fan-out area has a capacitance (C) of around 16 pF. The wiring of a gate high level signal line in a fan-out area has a capacitance of around 50 pF. Since the loading is excessively large, it would lead to poor displaying performance of a panel and the occurrence of mura.

### SUMMARY OF THE INVENTION

Thus, an object of the present invention is to provide a color filter (CF) substrate, which reduces the capacitances of gate lines, data lines, and some signal lines in fan-out areas and wire-on-array areas so as to reduce the loading of the gate lines, the data lines, and some signal lines to improve the displaying performance of a liquid crystal panel.

Another object of the present invention is to provide an indium-tin-oxide (ITO) film pattern structure of a CF substrate, which reduces the capacitances of gate lines, data lines, and some signal lines in fan-out areas and wire-on-array areas so as to reduce the loading of the gate lines, the data lines, and some signal lines to improve the displaying performance of a liquid crystal panel.

A further object of the present invention is to provide a liquid crystal display, which reduces the capacitances of gate lines, data lines, and some signal lines in fan-out areas and wire-on-array areas so as to reduce the loading of the gate lines, the data lines, and some signal lines to improve the displaying performance of a liquid crystal panel.

Yet a further object of the present invention is to provide a manufacturing method of a CF substrate, which can perform manufacture in such a way to reduce the capacitances of gate lines, data lines, and some signal lines in fan-out areas and wire-on-array areas so as to reduce the loading of the gate lines, the data lines, and some signal lines to improve the displaying performance of a liquid crystal panel.

To achieve the objects, the present invention provides a CF substrate, which comprises: a glass substrate, a black matrix and a CF unit formed on the glass substrate, and an ITO film pattern structure covering the black matrix and the CF unit. The ITO film pattern structure is composed of a first portion corresponding in shape to an effective display zone and second portions corresponding in shape to transfer pads.

The ITO film pattern structure is formed with a wet etching process.

The ITO film pattern structure is formed with a dry etching process.

The ITO film pattern structure is formed with a lift-off process.

The present invention provides an ITO film pattern structure of a CF substrate. The ITO film pattern structure is composed of a first portion corresponding in shape to an effective display zone and second portions corresponding in shape to transfer pads.

The present invention provides a liquid crystal display, which comprises: a thin-film transistor (TFT) substrate, a CF substrate, and a liquid crystal layer between the TFT substrate and the CF substrate. The CF substrate comprises: a glass substrate, a black matrix and a CF unit formed on the glass substrate, and an ITO film pattern structure covering the black matrix and the CF unit. The ITO film pattern structure is composed of a first portion corresponding in shape to an effective display zone and second portions corresponding in shape to transfer pads.

The present invention provides a method for manufacturing a CF substrate, which comprises:

(100) providing a glass substrate;

(200) forming a black matrix on the glass substrate;

(300) forming a CF unit on the glass substrate; and

(400) forming an ITO film pattern structure on the black matrix and the CF unit to make a CF substrate, wherein the ITO film pattern structure is composed of a first portion corresponding in shape to an effective display zone and second portions corresponding in shape to transfer pads.

Step (400) comprises:

(401) sputtering an ITO film on the glass substrate;

(402) uniformly applying a photoresist layer on the ITO film;

(403) patternizing the photoresist layer, the patterned photoresist layer being composed of a first portion corresponding in shape to an effective display zone and second portions corresponding in shape to transfer pads; and

(404) applying a wet etching operation to etch off portions of the ITO film that are not covered by the photoresist and finally applying a release agent to remove the patternized photoresist layer so as to obtain the glass substrate that has a desired ITO film pattern structure.

Step (400) comprises:

(411) sputtering an ITO film on the glass substrate;

(412) uniformly applying a photoresist layer on the ITO film;

(413) patternizing the photoresist layer, the patterned photoresist layer being composed of a first portion corresponding in shape to an effective display zone and second portions corresponding in shape to transfer pads; and

(414) applying a dry etching operation to etch off portions of the ITO film that are not covered by the photoresist and finally applying a release agent to remove the patternized photoresist layer so as to obtain the glass substrate that has a desired ITO film pattern structure.

Step (400) comprises:

(421) uniformly applying photoresist on the glass substrate;

(422) removing portions of the photoresist that correspond to the desired ITO film pattern structure on the glass substrate so as to form a patterned photoresist layer;

(423) sputtering an ITO film on the glass substrate that comprises the patterned photoresist layer; and

(424) carrying out a release operation on the glass substrate that comprises both the patterned photoresist layer and the ITO film in order to remove the patterned photoresist layer and the ITO film attached thereon so as to obtain the glass substrate that has a desired ITO film pattern structure.

The present invention provides a CF substrate and an ITO film pattern structure and a manufacturing method thereof and a liquid crystal display, which can lower down the capacitances of gate lines, data lines, and some signal lines in fan-out areas and wire-on-array areas so as to reduce the loading of the gate lines, the data lines, and the some signal lines thereby improving the displaying performance of the liquid crystal panel.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a top plan of an indium-tin-oxide (ITO) film pattern structure of a conventional color filter (CF) substrate;

FIG. 2 is top plan showing an ITO film pattern structure of a CF substrate according to the present invention; and

FIG. 3 is a flow chart illustrating a method for manufacturing a CF substrate according to the present invention.

### DETAILED DESCRIPTION OF THE PREFERRED EMBODIMENTS

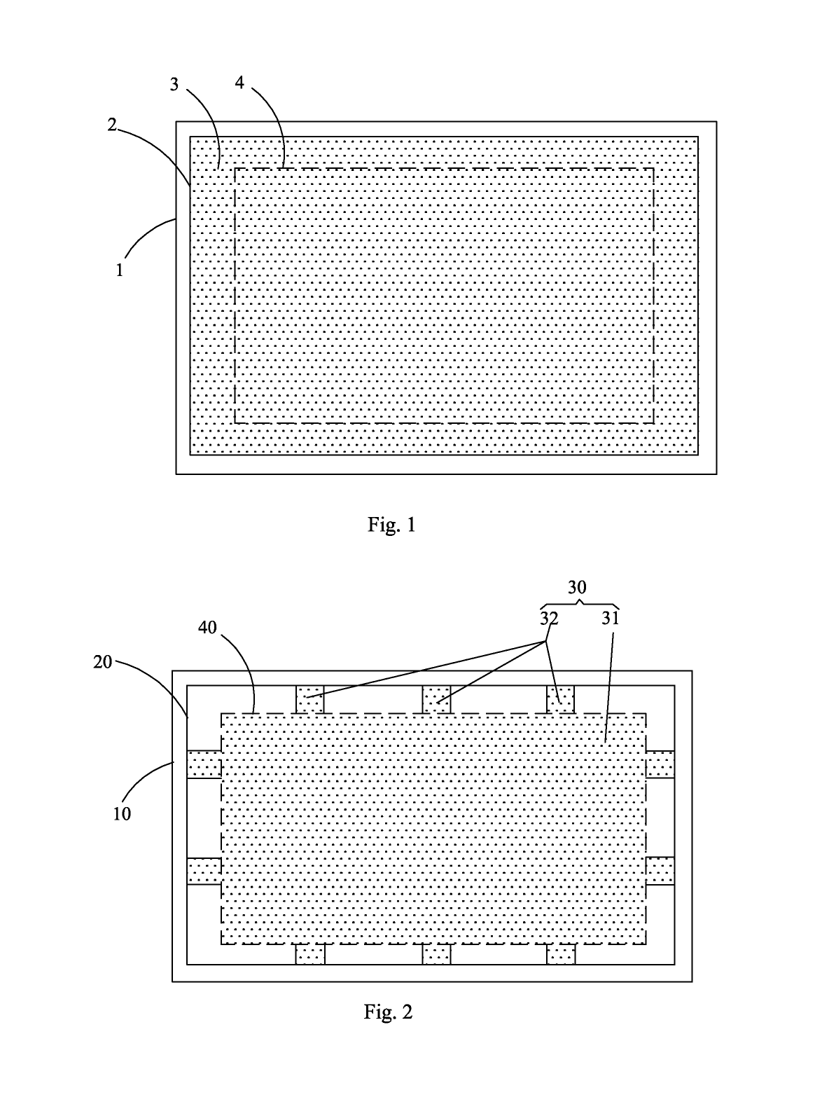

Referring to FIG. 2, a top plan view of an indium-tin-oxide (ITO) film pattern structure of a color filter (CF) substrate according to the present invention is shown. It can be seen from the spatial relationship that the CF substrate 20 is located above and corresponding to a thin-film transistor (TFT) substrate 10. In FIG. 2, an ITO film pattern structure 30 is indicated by an area in which dots are distributed. The ITO film pattern structure 30 is composed of a first portion 31 that corresponds in shape to an effective display zone 40 and second portions 32 that correspond in shape to transfer pads (which provides conduction to common electrodes (Com) of the TFT substrate side and the CF substrate side). In other words, as compared to an ITO film pattern structure of a conventional CF substrate shown in FIG. 1, the ITO film pattern structure 30 of the CF substrate 20 according to the present invention only keeps the portions of the ITO film that correspond to the effective display zone 40 (pattern that is necessary for rotating liquid crystal) and the transfer pads and omits the portions of the ITO film associated with fan-out areas and wire-on-array areas in order to reduce the capacitances of gate lines, data lines, and some signal lines in the fan-out areas and the wire-on-array sites. As such, the loading of the gate lines, the data lines, and said some signal lines can be reduced thereby facilitating size-enlargement of liquid crystal panels and enhancing displaying performance of large-sized liquid crystal panels.

The modified ITO film pattern structure 30 on one side of the CF substrate 20 according to the present invention allows capacitance of wiring in the wire-on-array areas and the fan-out areas to be lowered from the originally tens to hundreds pF all down to 0 pF. Specifically, taking the wiring capacitance of a data line in an fan-out area and that of a gate high level signal line in a fan-out area as an example, for situations before and after the ITO film pattern structure 30 on one side of the CF substrate 20 has been modified: before the modification, the wiring capacitance of a data line in a fan-out area is around 16 pF and the wiring capacitance of a gate high level signal line in a fan-out area is around 50 pF; and after the modification, the wiring capacitance of a data line in a fan-out area is around 0 pF and the wiring capacitance of a gate high level signal line in a fan-out area is around 0 pF.

Based on the ITO film pattern structure made according to the present invention, the present invention provides an associated CF substrate 20, which comprises: a glass substrate, a black matrix and a CF unit (not shown) formed on the glass substrate, and an ITO film pattern structure 30 covering the black matrix and the CF unit. The ITO film pattern structure 30 is composed of a first portion 31 corresponding in shape to an effective display zone 40 and second portions 32 corresponding in shape to transfer pads. By omitting the portions of an ITO film corresponding to fan-out areas and wire-on-array areas, capacitances of gate lines, data lines, and some signal lines in the fan-out areas and the wire-on-array sites can be lowered down. As such, the loading of the gate lines, the data lines, and said some signal lines can be reduced thereby facilitating size-enlargement of liquid crystal panels and enhancing displaying performance of large-sized liquid crystal panels.

The ITO film pattern structure 30 can be formed with a wet etching method. The development of this method has now been mature. The ITO film pattern structure 30 can alternatively be formed with a dry etching method, which is simple in operation and is environment-conservative. The ITO film pattern structure 30 can further alternatively be formed with a lift-off method, of which the operation is simple and efficient.

The modified ITO film pattern structure 30 on one side of the CF substrate 20 according to the present invention allows capacitance of wiring in the wire-on-array areas and the fan-out areas to be lowered from the originally tens to hundreds pF all down to 0 pF. Specifically, taking the wiring capacitance of a data line in an fan-out area and that of a gate high level signal line in a fan-out area as an example, for situations before and after the ITO film pattern structure 30 on one side of the CF substrate 20 has been modified: before the modification, the wiring capacitance of a data line in a fan-out area is around 16 pF and the wiring capacitance of a gate high level signal line in a fan-out area is around 50 pF; and after the modification, the wiring capacitance of a data line in a fan-out area is around 0 pF and the wiring capacitance of a gate high level signal line in a fan-out area is around 0 pF.

Based on the ITO film pattern structure of a CF substrate and the CF substrate according to the present invention, the present invention provides an associated liquid crystal display, which comprises: a TFT substrate 10, a CF substrate 20, and a liquid crystal layer (not shown) between the TFT substrate and the CF substrate. The CF substrate 20 comprises a glass substrate, a black matrix and a CF unit formed on the glass substrate, and an ITO film pattern structure 30 covering the black matrix and the CF unit. The ITO film pattern structure 30 is composed of a first portion 31 corresponding in shape to an effective display zone 40 and second portions 32 corresponding in shape to transfer pads. By omitting the portions of an ITO film corresponding to fan-out areas and wire-on-array areas, capacitances of gate lines, data lines, and some signal lines in the fan-out areas and the wire-on-array sites can be lowered down. As such, the loading of the gate lines, the data lines, and said some signal lines can be reduced thereby facilitating size-enlargement of liquid crystal panels and enhancing displaying performance of large-sized liquid crystal panels.

The ITO film pattern structure 30 can be formed with a wet etching method. The development of this method has now been mature. The ITO film pattern structure 30 can alternatively be formed with a dry etching method, which is simple in operation and is environment-conservative. The ITO film pattern structure 30 can further alternatively be formed with a lift-off method, of which the operation is simple and efficient.

The modified ITO film pattern structure 30 on one side of the CF substrate 20 according to the present invention allows capacitance of wiring in the wire-on-array areas and the fan-out areas to be lowered from the originally tens to hundreds pF all down to 0 pF. Specifically, taking the wiring capacitance of a data line in an fan-out area and that of a gate high level signal line in a fan-out area as an example, for situations before and after the ITO film pattern structure 30 on one side of the CF substrate 20 has been modified: before the modification, the wiring capacitance of a data line in a fan-out area is around 16 pF and the wiring capacitance of a gate high level signal line in a fan-out area is around 50 pF; and after the modification, the wiring capacitance of a data line in a fan-out area is around 0 pF and the wiring capacitance of a gate high level signal line in a fan-out area is around 0 pF.

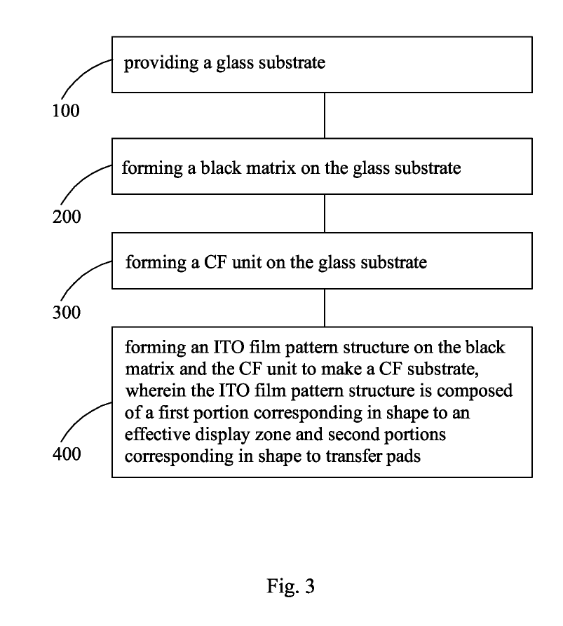

Referring to FIG. 3, a flow chart is shown to illustrate a manufacture method of the CF substrate 20 according to the present invention. The present invention provides a corresponding method for manufacturing the CF substrate 20, which comprises:

Step 100: providing a glass substrate;

Step 200: forming a black matrix on the glass substrate according to a known technique;

Step 300: forming a CF unit on the glass substrate according to a known technique; and

Step 400: forming an ITO film pattern structure 30 on the black matrix and the CF unit to make a CF substrate 20, wherein the ITO film pattern structure 30 is composed of a first portion 31 corresponding in shape to an effective display zone 40 and second portions 32 corresponding in shape to transfer pads.

In this method, the ITO film pattern structure 30 only keeps the portions of the ITO film that correspond to the effective display zone 40 (pattern that is necessary for rotating liquid crystal) and the transfer pads and omits the portions of the ITO film associated with fan-out areas and wire-on-array areas in order to reduce the capacitances of gate lines, data lines, and some signal lines in the fan-out areas and the wire-on-array sites. As such, the loading of the gate lines, the data lines, and said some signal lines can be reduced thereby facilitating size-enlargement of liquid crystal panels and enhancing displaying performance of large-sized liquid crystal panels.

The modified ITO film pattern structure 30 on one side of the CF substrate 20 allows capacitance of wiring in the wire-on-array areas and the fan-out areas to be lowered from the originally tens to hundreds pF all down to 0 pF. Specifically, taking the wiring capacitance of a data line in an fan-out area and that of a gate high level signal line in a fan-out area as an example, for situations before and after the ITO film pattern structure 30 on one side of the CF substrate 20 has been modified: before the modification, the wiring capacitance of a data line in a fan-out area is around 16 pF and the wiring capacitance of a gate high level signal line in a fan-out area is around 50 pF; and after the modification, the wiring capacitance of a data line in a fan-out area is around 0 pF and the wiring capacitance of a gate high level signal line in a fan-out area is around 0 pF.

The ITO film pattern structure 30 can alternatively formed with a wet etching method. The development of this method has now been mature. The above-described Step 400 can be carried out with the wet etching method, which comprises the following sub-steps:

Step 401: sputtering an ITO film on the glass substrate; this being achieved by a sputtering operation carried out in a vacuum coating machine;

Step 402: uniformly applying a photoresist layer on the ITO film;

Step 403: patternizing the photoresist layer, the patterned photoresist layer being composed of a first portion 31 corresponding in shape to an effective display zone 40 and second portions 32 corresponding in shape to transfer pads; this being achieved by steps including exposure and development; and

Step 404: applying a wet etching operation to etch off portions of the ITO film that are not covered by the photoresist and finally applying a release agent to remove the patternized photoresist layer so as to obtain the glass substrate that has a desired ITO film pattern structure 30.

In the above described step in which the wet etching process is applied to form the ITO film pattern structure 30, the specific operation flow and associated settings of parameters can be made according to any known techniques.

The ITO film pattern structure 30 can be alternatively formed with a dry etching method, which is simple in operation and is environment-conservative. The above-described Step 400 can be carried out with the dry etching method, which comprises the following sub-steps:

Step 411: sputtering an ITO film on the glass substrate;

Step 412: uniformly applying a photoresist layer on the ITO film;

Step 413: patternizing the photoresist layer, the patterned photoresist layer being composed of a first portion 31 corresponding in shape to an effective display zone 40 and second portions 32 corresponding in shape to transfer pads; and

Step 414: applying a dry etching operation to etch off portions of the ITO film that are not covered by the photoresist and finally applying a release agent to remove the patternized photoresist layer so as to obtain the glass substrate that has a desired ITO film pattern structure 30.

In the above described step in which the dry etching process is applied to form the ITO film pattern structure 30, the specific operation flow and associated settings of parameters can be made according to any known techniques.

The ITO film pattern structure 30 can be alternatively formed with a lift-off method, of which the operation is simple and efficient. The above-described Step 400 can be carried out with the lift-off method, which comprises the following sub-steps:

Step 421: uniformly applying photoresist on the glass substrate;

Step 422: removing portions of the photoresist that correspond to the desired ITO film pattern structure on the glass substrate so as to form a patterned photoresist layer;

Step 423: sputtering an ITO film on the glass substrate that comprises the patterned photoresist layer; and

Step 424: carrying out a release operation on the glass substrate that comprises both the patterned photoresist layer and the ITO film in order to remove the patterned photoresist layer and the ITO film attached thereon so as to obtain the glass substrate that has a desired ITO film pattern structure 30.

In the above described step in which the lift-off process is applied to form the ITO film pattern structure 30, the specific operation flow and associated settings of parameters can be made according to any known techniques.

In summary, the present invention provides a CF substrate and an ITO film pattern structure and a manufacturing method thereof, and a liquid crystal display, which lower down the capacitances of gate lines, data lines, and some signal lines in fan-out areas and wire-on-array area so as to reduce loading of the gate lines, the data lines, and said some signal lines to improve displaying performance of the liquid crystal panel.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A color filter (CF) substrate, comprising: a glass substrate, a black matrix and a CF unit formed on the glass substrate, and an indium-tin-oxide (ITO) film pattern structure covering the black matrix and the CF unit, the ITO film pattern structure being composed of a first portion corresponding in shape to an effective display zone and second portions corresponding in shape to transfer pads.

2. The CF substrate as claimed in claim 1, wherein the ITO film pattern structure is formed with a wet etching process.

3. The CF substrate as claimed in claim 1, wherein the ITO film pattern structure is formed with a dry etching process.

4. The CF substrate as claimed in claim 1, wherein the ITO film pattern structure is formed with a lift-off process.

5. An ITO film pattern structure of a CF substrate, the ITO film pattern structure being composed of a first portion corresponding in shape to an effective display zone and second portions corresponding in shape to transfer pads.

6. A liquid crystal display, comprising: a thin-film transistor (TFT) substrate, a CF substrate, and a liquid crystal layer between the TFT substrate and the CF substrate, the CF substrate comprising a glass substrate, a black matrix and a CF unit formed on the glass substrate, and an ITO film pattern structure covering the black matrix and the CF unit, the ITO film pattern structure being composed of a first portion corresponding in shape to an effective display zone and second portions corresponding in shape to transfer pads.

7. A method for manufacturing a CF substrate, comprising:
(100) providing a glass substrate;
(200) forming a black matrix on the glass substrate;
(300) forming a CF unit on the glass substrate; and
(400) forming an ITO film pattern structure on the black matrix and the CF unit to make a CF substrate, wherein the ITO film pattern structure is composed of a first portion corresponding in shape to an effective display zone and second portions corresponding in shape to transfer pads.

8. The method for manufacturing a CF substrate as claimed in claim 7, wherein step (400) comprises:
(401) sputtering an ITO film on the glass substrate;
(402) uniformly applying a photoresist layer on the ITO film;
(403) patternizing the photoresist layer, the patterned photoresist layer being composed of a first portion corresponding in shape to an effective display zone and second portions corresponding in shape to transfer pads; and
(404) applying a wet etching operation to etch off portions of the ITO film that are not covered by the photoresist and finally applying a release agent to remove the patternized photoresist layer so as to obtain the glass substrate that has a desired ITO film pattern structure.

9. The method for manufacturing a CF substrate as claimed in claim 7, wherein step (400) comprises:
(411) sputtering an ITO film on the glass substrate;
(412) uniformly applying a photoresist layer on the ITO film;
(413) patternizing the photoresist layer, the patterned photoresist layer being composed of a first portion corresponding in shape to an effective display zone and second portions corresponding in shape to transfer pads; and
(414) applying a dry etching operation to etch off portions of the ITO film that are not covered by the photoresist and finally applying a release agent to remove the patternized photoresist layer so as to obtain the glass substrate that has a desired ITO film pattern structure.

10. The method for manufacturing a CF substrate as claimed in claim 7, wherein step (400) comprises:
(421) uniformly applying photoresist on the glass substrate;
(422) removing portions of the photoresist that correspond to the desired ITO film pattern structure on the glass substrate so as to form a patterned photoresist layer;
(423) sputtering an ITO film on the glass substrate that comprises the patterned photoresist layer; and
(424) carrying out a release operation on the glass substrate that comprises both the patterned photoresist layer and the ITO film in order to remove the patterned photoresist layer and the ITO film attached thereon so as to obtain the glass substrate that has a desired ITO film pattern structure.
